(19) United States
(12) Patent Application Publication
(10) Pub. No.: US 2008/0257385 A1
(43) Pub. Date: Oct. 23, 2008

(54) Method and Device for Cleaning an Electrode Used in Resistance Point Welding or a Cap and Device for Resistance Point Welding

(76) Inventors: Emil Schubert, Allendorf-Lumda (DE); Jorg Faber, Wetzlar-Dudenhofen (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/596,774

(22) PCT Filed: May 14, 2005
(86) PCT No.: PCT/EP05/05306

§ 371 Date: Nov. 17, 2006

(30) Foreign Application Priority Data
May 21, 2004 (DE) 10-2004-024-0979.

(51) Int. Cl. B08B 7/02

(52) U.S. Cl. 134/17

(57) ABSTRACT

The invention relates to a method for cleaning an electrode (1) used in resistance point welding, particular a cap (2) which can be placed on the electrode. According to the invention, the electrode (1) and/or the cap (2) are impinged upon with a cold medium. The temperature difference between the cold medium and the functional parts to be cleaned is greater than 80 Kelvin and the temperature of the functional parts is above room temperature. The invention also relates to an electrode (1) for resistance point welding, in addition to a cap (2) which can be placed on the electrode (1). According to the invention, the electrode (1) and/or the cap (2) has a feed direction for supplying the cold medium.

The invention relates to a method for cleaning an electrode used in resistance point welding according to the preamble of claim 1, an electrode for resistance point welding according to the preamble of claim 8, a cap which can be placed on an electrode according to the preamble of claim 9, as well as a device for resistance point welding according to claim 12.

Such electrodes or electrode caps used in resistance point welding are known, for example, from U.S. Pat. No. 5,387,774 A.

During the welding process, welding spatters form, which deposit in and on all functional parts of the welding apparatus, for instance on the electrode of a resistance point welding apparatus or on the gas nozzle of an arc welding apparatus, and have to be removed from time to time.

For this purpose mechanical as well as non-contact methods are known.

For mechanical cleaning, a rotating tool, such as a cap cutter, for example, is typically used, which is adapted to the contour of the electrode or the cap. The disadvantage of mechanical machining is that the surfaces to be cleaned can be damaged and roughened by coming in contact with the tool such as the cutter, knife, and brushes, which can result in even quicker and greater impurities. Furthermore, the tools have to be adapted to the respective geometry of the electrode, which is associated with the corresponding complexity.

From DE 42 18 836 A1 it is principally known to conduct a cold treatment by applying a cryogenic stream in order to remove impurities on surfaces, for example with nitrogen and/or dry ice. The effect of the low temperature results in embrittlement and subsequently in chipping of the impurities that are located on the surfaces.

A non-contact method is known from the WO 02 49794 A1, however it is for the cleaning of an arc welder or cutting torch, wherein a cold blasting abrasive mixture comprising CO₂-pellets and compressed air is used. The problem here, which incidentally also applies to mechanical cleaning methods, is that in particular with automatically operating systems, such as robot torches, these have to be moved separately from the cleaning stations. These position changes of the torches for the cleaning process interrupt the workflow.

Finally, it is known from the EP 0 074 16 A1 to apply compressed air on a robot torch via its gas connector on the torch body in order to blow air through the gas nozzle from the inside. The low cleaning effect is disadvantageous with this known method.

Proceeding from the above, it is the object of the invention to provide a method, specifically for resistance point welding, for cleaning an electrode, in particular a cap that is placed on the electrode, which allows effective cleaning of the welding apparatus without extended disruptions of the work flow. Furthermore, it is the object of the invention to provide a resistance point welding device that is suitable for the method.

So as to achieve the object, a method is proposed that has the characteristics mentioned in claim 1. The method is characterized in that the electrode and/or the cap are impinged upon with a cold medium, wherein the temperature difference between the cold medium and the functional parts to be cleaned is greater than 80 Kelvin and the temperature of the functional parts is above room temperature.

By the impinging upon the functional parts to be cleaned with a cold medium, quick cooling (so-called quick-freezing) is achieved. As a result of the differences in the material properties between the functional parts on one hand, such as the electrode and if applicable the cap, and the impurities on the other hand, such as the welding splatters for example, different distinct shrinkage processes of the functional parts occur in relation to the contaminants, resulting in the detachment of the contaminants adhering to the surfaces. The detached contaminants can then simply be removed by blowing them off with compressed air or they simply fall off the electrode or cap. Since the electrode to be cleaned, or the cap that is placed thereon, does not have to be moved to a separate cleaning station, the inventive method significantly shortens the overall cleaning time. Furthermore, a separate cleaning station is no longer needed. Surprisingly it was also noticed that the application of the cold medium through the electrode and/or cap does not result in the expected embrittlement of these components, such as further impinged-on plastic parts or electronic components, if applicable. For the supply of the cold medium, the existing medium feed devices of the welding apparatus can be used during the cleaning phase. Of course it is also possible to provide separate feed devices.

According to a further development of the invention, it is provided to feed the cold medium from the side of the electrical supply of the electrode and/or laterally. Since in this embodiment, feeding from the front, meaning from the front end of the electrode or the cap, is avoided, the electrode can stay aligned in its welding position for the cleaning process, resulting in considerable time savings compared to front end feeding of the cold medium.

According to a particular embodiment of the invention, it is provided that the temperature of the medium is less than 77 Kelvin. When the medium has this temperature, particularly effective and fast cleaning of the electrode and/or the cap can be achieved.

According to a further embodiment of the invention, it is provided that the medium is a mixture that comprises a carrier medium and particles in a solid or liquid phase, in particular when cleaning the electrode and/or the cap from the outside. Through the kinetic energy of the particles, the cleaning effect can be influenced in a positive manner.

Advantageously, the carrier medium that is used is compressed air and/or carbon dioxide, which are basically—particularly in the case of compressed air—readily available if automatic equipment is used.

It is particularly advantageous if dry ice, dry ice pellets, and/or carbon dioxide snow are used as the medium or as particles of the mixture. The dry ice pellets or carbon dioxide snow produce mechanical energy when impinging upon the surfaces to be cleaned, which additionally improves the cleaning effect.

Furthermore, it is advantageous if the medium is pressurized carbon dioxide in liquid form.

To achieve the object, it is also proposed to use an electrode for resistance point welding that has the characteristics mentioned in claim 8. The electrode comprises a known feed device for feeding a cooling agent, particularly in the area of the electrode tip. According to the invention, it is provided that the feed device for supplying cold medium is designed according to claims 1 to 7. Using the cold medium effects the cleaning of the electrode, particularly of the electrode tip, since the electrode and the contaminants adhering thereto each perform different material expansions as a result of the quick cooling process (quick-freeze) due to their different material properties, which means that the contaminants shrink more than the electrode, resulting in the detachment of the contaminants. The electrode according to the invention has the advantage that cleaning can be carried out in a simple way without performing structural changes on the electrode. During the welding process, the feed device supplies cooling medium, for example cooling water, in the electrode or in the electrode tip. During the cleaning process, the same feed device then supplies particularly a cold medium instead of the cooling medium into the electrode. In principle, it is also possible to cool the electrode with the cold medium during the welding process, so that the cooling medium or water can be foregone.

To achieve the object, a cap that can be placed on an electrode that is used for resistance point welding according to claim 9 is proposed. The cap is characterized by a feed device for supplying cold medium into the cap according to the claims 1 to 7. Therefore, as a result of the above-described shrinkage effect, a cleaning process of the cap occurs, meaning a detachment of the contaminants that are deposited on the cap surface. By feeding the cold medium into the cap, it is naturally also possible to detach contaminants—if any are present—from the surface of the electrode that was not covered by the cap. This requires, however, that the supply of cold medium into the cap also cools the part of the electrode that is to be cleaned such that the temperature difference between the cold medium and the electrode surface to be cleaned is greater than 80 Kelvin and the temperature of the surface to be cleaned is above room temperature.

According to one embodiment of the invention, it is provided that the feed device is formed by at least one feed channel. With the feed channel, targeted feeding of the cold medium into the cap is possible, so that optimal cold medium supply of the cap can be assured.

The feed channel can be configured as a through-bore. With the through-bore, penetration of the electrode and/or the cap with cold medium is possible. The feed channel can also be configured as a tapped blind hole. The tapped blind hole particularly lends itself if the cold medium is fed into the feed channel in intervals using pressure pulses. Between the pressure pulses, the cold medium substantially rests unpressurized against the feed channel, which results in backflow of the previously fed cold medium during the interval pauses. If the cold medium, particularly the CO₂, is fed into the feed device in the liquid phase, during the feeding process a relaxation occurs and therefore a sublimation of the medium from liquid to CO₂ snow to gaseous. In the interval pauses then, backflow of the now gaseous medium from the feed device and/or the tapped blind boreholes occurs. In another advanced embodiment of the invention, it is provided that the feed channel is disposed such that the cold medium enters the cap laterally from the current supply side of the electrode. The current supply side should be understood as the side that extends over the centerline of the electrode, or substantially over the centerline of the electrode. By using this type of feeding, the cold medium is fed quasi from the back and not from the front, meaning not from the front side of the electrode and/or cap. This makes it possible to allow the electrode with the cap to remain in the welding position during the cleaning process, thus saving setup time.

The cap according to the invention furthermore has the advantage that it can also be used for cooling the electrode tip during the welding process. It can be provided to impinge upon the cap with cooling water or another cooling medium instead of the cold medium during the welding process, and in the case of cleaning the cold medium is used. Certainly it is also possible with the cap to use the cold medium for cleaning as well as cooling the electrode during the welding process.

Finally, to achieve the object a device for resistance point welding is proposed. The device has an electrode according to the characteristics of claim 8 or an electrode that is not supplied with cooling agent and optionally a cap that is placed on the electrode according to the characteristics of claims 9 to 11, as well as a controller. The controller is functionally connected to the electrode and the cap. Furthermore, it is provided that the controller is configured for controlling the feeding and the blocking of the cold medium according to the characteristics of claims 1 to 7. In an advantageous manner, the controller already installed on the resistance point welding apparatus or on the welding equipment is used for feeding the cold medium as well.

Further objectives, advantages, characteristics and applications of the present invention are apparent from the following description of exemplary embodiments with reference to the drawings. All described and/or illustrated characteristics, by themselves or in any suitable combination, form the object of the present invention, even independently from the abstract in the claims or their reference back to the claims.

Shown are:

FIG. 1 shows a longitudinal view of a possible embodiment of an electrode for resistance point welding that is configured for the cleaning process according to the invention,

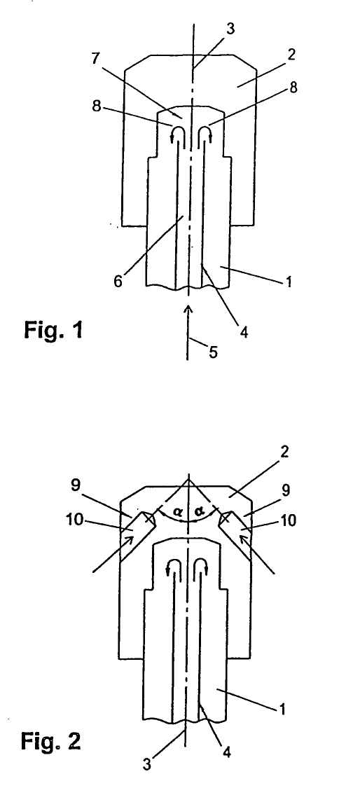

FIG. 2 shows a longitudinal view of a possible embodiment of a cap that is placed on an electrode with a water-cooling system, which cap is configured for the cleaning process according to the invention, and

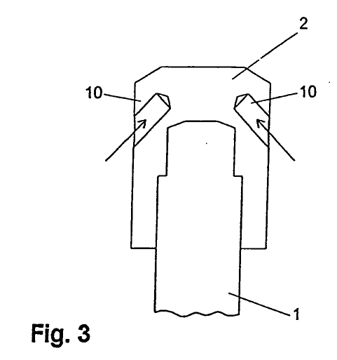

FIG. 3 shows a cap according to FIG. 2, placed on an electrode without water-cooling system.

FIG. 1 illustrates the end of an electrode 1 that is used for resistance point welding, which end faces the welding tool during the welding process. Centrically on the longitudinal axis of the electrode 1, a cap 2 is located, which is placed on the end of electrode 1.

The electrode 1 has a feed device 4 for supplying a cooling agent in the direction of the arrows 5. The cooling agent serves the cooling of the electrode 1, particularly of the electrode tip during the welding process. Usually cooling water is used as the cooling agent. The feed device supplies the cooling agent into the end area 7 of the electrode 1 via a cooling channel 6. There it flows around this end area 7, then it is diverted in the direction according to arrow 8 and then it flows back through backflow channels, which are not shown here, which means starting from the electrode tip backwards.

In this embodiment, the feed device is configured such that cold medium can be supplied for cleaning welding spatter adhering to the electrode. This takes place in a scheduled manner, specifically such that the cold medium is supplied during the cleaning phase and the cooling agent during the welding process. The cold medium is preferably liquid carbon dioxide and/or a phase mixture of carbon dioxide. The cold temperature of the medium is created by the relaxation of the carbon dioxide when it leaves the carbon dioxide bottle, wherein the developing cold evaporation temperature cools down the liquid carbon dioxide and/or the phase mixture of carbon dioxide. Depending on the extent of the relaxation and the occurring cold evaporation temperature, cooling to below 210 Kelvin can be achieved, resulting in the formation of dry snow.

Cleaning of the electrode 1 and/or cap 2 is based on the so-called quick-freezing process, wherein different levels of shrinkage processes of the electrode 1 and/or cap 2 and of the adhering impurities occur, so that the deposited impurities then become detached or can be easily blown off with compressed air.

The embodiment shown in FIG. 2 differs from the embodiment according to FIG. 1 in that here the cap 2 that is placed on the electrode 1 has a feed device 9 for supplying the cold medium, wherein feeding occurs into the cap 2. The feed device 9 if formed by several feed channels 10. The feed channels 10 are disposed at an angle α to the longitudinal axis 3, specifically in such a manner that the cold medium enters laterally from the longitudinal axis, which at the same time forms the current supply side of the electrode. The angle α can range between 10 and 45 degrees; preferably it is 20 degrees.

The feed channels 10 are disposed symmetrically around the circumference of the cap 2. The entrance part of the feed channels is shown in FIG. 2. Through this part, cold medium enters the cap 2, specifically in another part of the feed channels 10, which are not shown in FIG. 2, via which part the cold medium is then directed out of the cap 2. The cap 2 is supplied with cold medium entirely from the side of the cap 2. The front side of the cap 2 remains unchanged. Since the welding process takes place via the cap 2, the cap 2 does not need to be removed from the electrode 1 for cleaning.

In FIG. 2—as well as in FIG. 1—the electrode 1 has a feed device 4, which supplies the electrode 1 with cooling agent during the welding process. In the embodiment illustrated here, the cleaning and/or the supply of cold medium for cleaning takes place via the cap 2 and the cooling of the electrode during the welding process takes place via the feed device 4, independently of the feed device 9 of the cap 2. Alternatively, it is possible that the feed device 4 of the electrode 1—as described in FIG. 1—is also configured to supply the cold medium. In this case, the cold medium is supplied into the cap and/or into the electrode 1. Alternatively, the electrode 1 may also be configured as an electrode without water cooling. In this embodiment as well, it is possible to loosen the impurities by feeding the cold medium into the cap 2 via the feed device 9. In any case, no separate independent cleaning devices for cleaning the electrode 1 and/or the cap 2 have to be provided.

### REFERENCE NUMERAL LIST

1—Electrode
2—Cap
3—Longitudinal axis
4—Feed device (electrode)
5—Flow direction of cooling agent
6—Cooling channel
7—End area
8—Flow direction of cooling agent
9—Feed device (cap)
10—Feed channel
11—Electrode not supplied with cooling agent

1. A method for cleaning an electrode (1) used for resistance point welding, particularly a cap (2) that is placed on the electrode (1), characterized in that the electrode (1) and/or the cap (2) are impinged upon with a cold medium in order to detach impurities by means of shrinkage, the temperature difference between the cold medium and the functional parts to be cleaned being greater than 80 Kelvin and the temperature of the functional parts being above room temperature.

2. The method according to claim 1, characterized in that the medium is fed from the current supply side of the electrode (1) and/or laterally.

3. A method according to any one of the preceding claims, characterized in that the temperature of the medium is lower than 77 Kelvin.

4. A method according to any one of the preceding claims, characterized in that the medium is a mixture, comprising a carrier medium and particles in solid and/or liquid phase.

5. The method according to claim 4, characterized in that the carrier medium is compressed air and/or carbon dioxide.

6. A method according to any one of the preceding claims, characterized in that dry ice, dry ice pellets and/or carbon dioxide snow are used as the medium or as the particles of the mixture.

7. A method according to any one of the preceding claims, characterized in that the medium is pressurized carbon dioxide in liquid form.

8. A method according to any one of the preceding claims, characterized in that the cold medium is fed in pressure pulses.

9. An electrode for resistance point welding with a feed device (4) for supplying a cooling agent, particularly in the area of the electrode tip, characterized in that the feed device (4) is configured to supply a cold medium according to the claims 1 to 7.

10. A cap that is placed on an electrode (1) used for resistance point welding, characterized by a feed device (9) for feeding a cold medium according to the claims 1 to 7 into the cap (2).

11. The cap according to claim 10, characterized in that the feed device (9) is formed by at least one feed channel (10).

12. The cap according to claim 11, characterized in that the feed channel (10) is disposed such that the cold medium enters the cap (2) laterally from the current supply side of the electrode (1).

13. A device for resistance point welding with an electrode (1) according to claim 9 or an electrode not supplied with cooling agent and optionally a cap (2) that is placed on the electrode according to claims 10 to 12 and with a controller, which is functionally connected with the electrode and the cap (2) and is designed to control the feeding and blocking of the cold medium according to the claims 1 to 8.
